(19) United States
(12) Patent Application Publication
(10) Pub. No.: US 2006/0218490 A1
(43) Pub. Date: Sep. 28, 2006

(54) Method and apparatus for creating a web page

(76) Inventor: Richard Fink, Naples, FL (US)

Correspondence Address: Wilson Daniel Swayze, Jr, 3804 Clearwater Ct., Plano, TX, 75025, US

(21) Appl. No.: 11/088,535

(22) Filed: Mar. 24, 2005

(51) Int. Cl. G06F 17/00

(52) U.S. Cl. 715/517

(57) ABSTRACT

Using standard web languages such as HTML, JavaScript, and CSS, specially configured elements are included in a web page to enhance the sizing (and/or resizing) behavior of the page as it is displayed by a browser, particularly the Microsoft Internet Explorer browser and others made with the same underlying technology. These elements enable the creator of the page to transparently augment the sizing action of the browser, first, by using the browser's inherent sizing action to register the user's selection in the browser's Text Size menu and, second, by temporarily suspending that same inherent action pending script-driven modifications to the size-related settings of the page. In so doing, many of the restrictions ordinarily imposed by the browser may be overcome, such as the inability to size and resize, in reference to the user's selection in the browser's Text Size menu, a web page having contents set in pixels.

### BACKGROUND OF THE INVENTION

1. Technical Field

The present invention relates, in general, to a method for modifying the way in which the contents of a web page are sized or resized by a browser, particularly the Microsoft Internet Explorer browser (IE). More particularly, to a method with which the web page's author can influence and thereby enhance, for the benefit of the computer user, the behavior associated with IE's built-in sizing and resizing interface, its Text Size menu.

2. Description of The Related Art

A Web Browser as shown in FIG. 4 is a computer application designed to display a text document authored, most commonly, with a combination of three languages, namely Hyper-Text Markup Language (HTML), script (JavaScript) and Cascading Style Sheets (CSS).

None of these languages, in and of themselves, provide a mechanism for the user to override the author's specified sizes and thus allow the user to enlarge or reduce the displayed size of text and images within the browser. There is no detailed, standardized technique that applies to the problem. Historically, each browser maker has decided how and in what way to provide a sizing and resizing feature.

Internet Explorer (IE) for Windows as shown in FIG. 3, is the world's most-used browser, with an estimated 90%+market share and an estimated 250 million+users worldwide. As part of its user interface, Internet Explorer has a menu named “Text Size” which offers the user six settings: smallest, smaller, medium, larger, and largest. This is also true for other browsers built on Internet Explorer technology, including Netcaptor, Avant Browser, and Maxthon, although the Text Size menu might, in some cases, be named something else.

The Text Size menu is provided as an accessibility feature: its purpose is to allow the user to enlarge or reduce the size of text on a web page to suit their preference.

The problem is that IE's Text Size menu has a precondition attached: it does not enlarge or reduce the size of text unless the author of the web page has followed restrictive rules in the construction of the page. More specifically, the Text Size menu only responds when the author has set font sizes using ems, percents, keywords, or the now obsolete Font tag. It will not resize text set in any other unit, such as pixels or points. For example, if the text in the web page has been set in pixels, and an IE user expresses another preference by clicking “larger” in the Text Size menu, no resizing by the browser takes place. In practice, this creates an accessibility problem for many computer users, particularly older users who may have trouble reading small text.

This behavior is also especially problematic and disappointing to the many web authors who wish to size in pixel units because it is generally acknowledged that the pixel unit provides the most consistent result from platform to platform and browser to browser and is the easiest to control so as to get a consistent and predictable result.

For the most part, web developers have dealt with this situation in one of three ways. The first and, unfortunately, most prevalent way has been to size in pixel units regardless of the consequences and therefore leave IE users with no way resize the contents of the web page. The second way has been to work within the restrictions and cope with the complications, uncertainties, and inconveniences inherent in using em, percent, and keyword units. The third way has been to create, on the web page itself, an alternative sizing/resizing interface to allow the user to initiate a script-driven resizing of the web pages contents.

This third approach has many disadvantages. First, valuable space must be set aside on the web page for the interface, be it a button, or drop-down menu, or some other HTML “widget”. A second disadvantage is that this “fix” gets applied even when the fix isn't necessary. For example, unlike IE, competing browsers such as Opera or Mozilla Firefox do have resizing features that give the user the ability, independently of the way sizes are specified in the web page, to either zoom the entire contents of the page (as Opera does with its Page Zoom feature) or resize text (as Mozilla Firefox does with its Text Size feature).

A third disadvantage is that, in not targeting IE specifically as the problem, the scripting techniques used to affect the resize are limited to those that work “cross-browser” and, therefore, certain unique features of IE must remain ignored. For example, unlike other browsers, IE has a CSS zoom property which can be used to zoom the entire contents of a page, both text and images, and this ability cannot be brought to bear with an approach that insists on applying the same technique to the page as viewed in all browsers.

Yet another disadvantage of this approach relates to the problem of getting the user's sizing preference to persist from page to page. When using an alternative interface on the web page itself, cookies must be used to achieve persistence or else the user must re-select their preference as they browse to and from each and every page. However, cookies require additional script and cookies may be disabled in the browser because of security and privacy concerns. In contrast, the user's selection in IE's Text Size menu automatically persists from page to page and cannot be turned off. Therefore, it would be greatly advantageous to both IE users and web authors alike, if the default behavior of IE's native sizing interface, its Text Size menu, could be “overridden” and, instead, be used to initiate a script-driven sizing and/or resizing of a web page's contents using the full range of techniques provided by IE's script interpreter. In so doing, no alternative interface would need to be created on the web page itself, persistence would be built-in, and users of other browsers need not be subjected to a remedy for which they have no ailment.

### SUMMARY OF THE INVENTION

It is therefore an object of the present invention to provide, within a web page, a way to detect the user's selection in IE's Text Size menu when the web page first loads but before the contents of the web page display so the page's sizing behavior can be modified using the full range of scripting options made available by the browser.

It is an additional object of the present invention to provide, within a web page, a way to detect when the user makes a new selection in the Text Size menu after the web page has loaded so that the page's resizing behavior can be modified using the full range of scripting options made available by the browser.

An additional object of the present invention is that it allows the web developer to enhance the usual workings of the browser's Text Size menu in its totality, both when the current selection is applied by the browser when the web page first loads and also when the web page has loaded and a resizing is initiated by the user having made a new selection.

Using the present invention, IE's Text Size menu is made to come alive with new functionality by allowing the author of the web page to offer the computer user an enhanced and more finely-tuned result, including the ability to size and resize the contents of a web page set in pixels.

Using the present invention, the full range of IE's scripting abilities may be brought to bear, including: switching style sheets; changing the base font-size of the entire page; enlarging and reducing text, images, or both using IE's CSS zoom property; or sizing each element of the page individually using the Document Object Model.

An additional object of the present invention is that it be simple and easy to apply, using languages common to web authors everywhere: HTML, Jscript and CSS. (Jscript being Microsoft's variant of ECMA-262 or, as it more commonly called, JavaScript) In keeping with this, an additional object of the present invention is that, being constructed of standard web languages inherently interpretable by the browser by default, the user is not required to install it as an “add-on” to the browser as is the case with a plug-in or ActiveX control. Such add-ons are bothersome for the user to install, often require special security clearance, and are notoriously difficult to pass through Internet firewalls.

An additional object of the present invention is that it be transparent to the user in that it leaves the general “look and feel” of the Text Size menu's workings intact.

The above as well as additional objects, features, and advantages of the present invention will become apparent in the following detailed written description.

### BRIEF DESCRIPTION OF THE DRAWINGS

FIG. 1 illustrates a flow chart of the present invention;

FIG. 2 illustrates another flow chart of the present invention;

FIG. 3 illustrates a text size menu of IE;

FIG. 4 illustrates an prior art illustration of the browser;

FIG. 5 illustrates an apparatus for an implementation of the present invention.

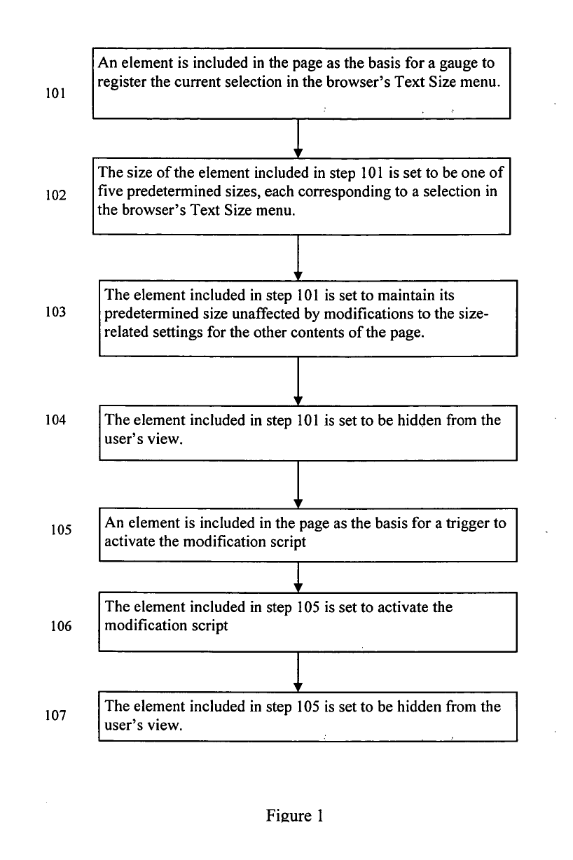

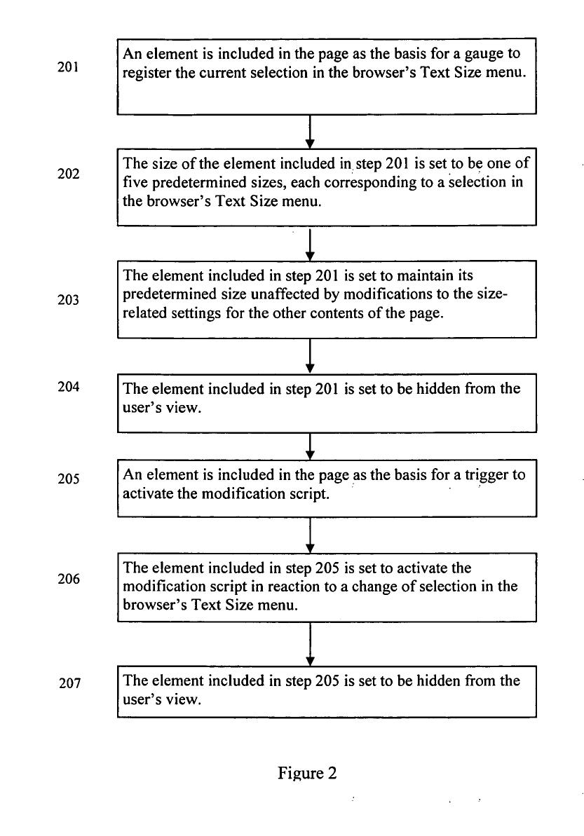

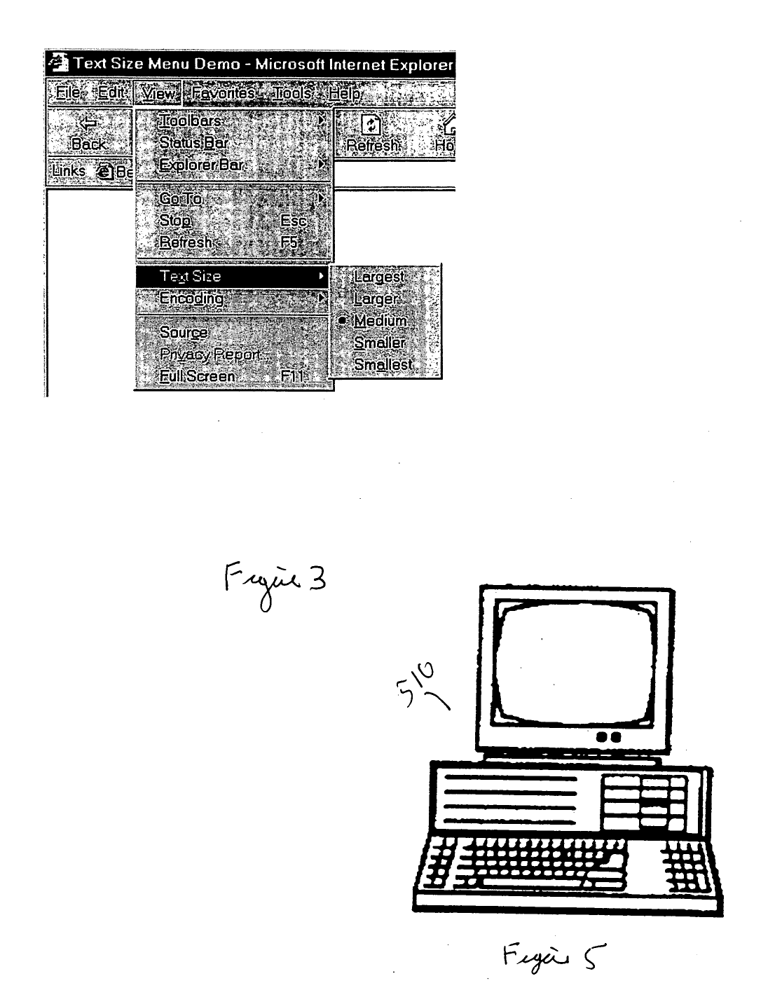

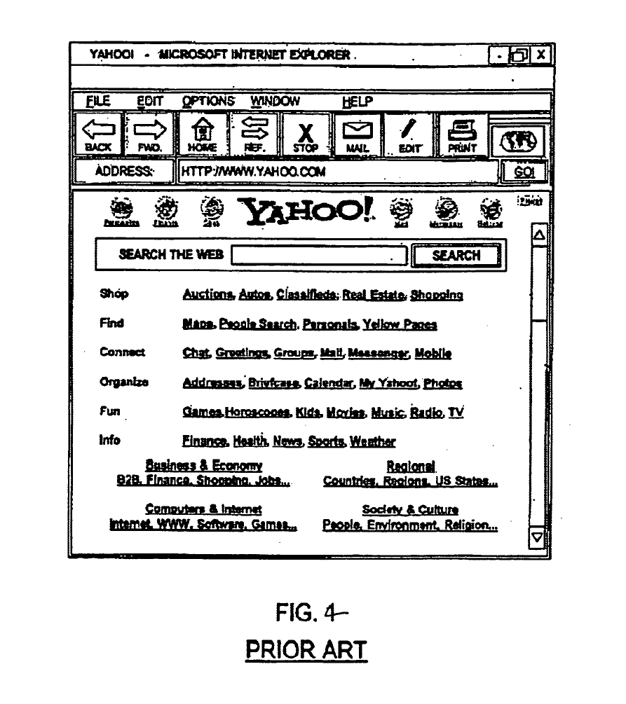

### DETAILED DESCRIPTION

In order to facilitate a complete understanding of the invention, the remainder of the detailed description is arranged within the following sections as follows:

I. Glossary Of Terms and Acronyms

II. Preferred Embodiment

III. Alternative Embodiment

IV. Conclusion, Ramifications, and Scope

Further, the Preferred Embodiment (Section II) and the Alternative Embodiment (Section III) are each presented within the following sub-sections:

A. Creating a modification script

B. Creating a gauge

C. Creating a loading phase trigger

D. Creating a loaded phase trigger

E. Disabling the gauge and two triggers in other browsers

F. Complete Working Example

I. Glossary of Terms and Acronyms

As used herein, the following terms, phrases, and acronyms are defined as follows:

browser: a browser based on Microsoft Internet Explorer technology (especially Internet Explorer versions 5.0 or higher) that has, as part of it's user interface, a Text Size menu or its equivalent, presenting the browser user with five selections: largest, larger, medium, smaller, and smallest.

style rule(s): a rule included in a web page in conformance with the World Wide Web Consortium's recommendation for Cascading Style Sheets (CSS), an extension to HTML that allows style features such as color, font-size, spacing, and more, to be specified for certain elements of an HTML document.

default style rule(s): a style rule or equivalent style property applied to an HTML element by the browser when no other CSS style rule for it is specified by the web developer.

element: an HTML element or its equivalent.

IE: the Microsoft Internet Explorer browser.

loading phase: a period of time that starts when the browser first begins to receive the contents of a web page and ends with all of the contents having been received and the firing of the window object's—or body element's—onload event.

loaded phase: a period of time that starts after the browser has received all the contents of a web page and has made a first complete display of the page and ends when the page is either reloaded or the page is no longer displayed by the browser.

other browser(s): a browser built on technology other than Microsoft Internet Explorer that does not feature a Text Size menu or its equivalent; also including Microsoft Internet Explorer versions 4.0 and lower.

page: an Internet web page.

resizing: a term that refers to the way the browser resizes the contents of a web page in response to a user's new selection in the browser's Text Size menu after the page has loaded and has been displayed by the browser.

sizing: a term that refers to the way the browser sizes the contents of a web page during the loading phase.

user: the person who uses the browser at the computer

web developer: the person who creates the web page

web standards: a group of open specifications such as CSS, HTML, and XML, developed by the World Wide Web Consortium (W3C) to enhance the interoperability of Web-related products.

World Wide Web Consortium (W3C): an international industry consortium that publishes open specifications such as HTML and Cascading Style Sheets.

II. Preferred Embodiment

A. Creating a Modification Script

A-1. Script is placed within the page that will modify in some way, the size-related settings of the contents of the page in reference to the current selection in the browser's Text Size menu as registered by the gauge created in sub-section B (Creating a gauge).

The following script function named modifyTexto provides a framework illustrating the form that a typical modification script might take. As in line 04, the script includes an object reference to an element that's size, in pixels, is measured. It then compares that size to a group of five predetermined sizes to determine the current selection in the browser's Text Size menu as in lines 05 thru 26.

The function name modifyText( ) has no special significance and the web developer is free to do whatever makes sense to achieve the desired modification to the page's size-related settings and resulting behavior.

(A complete working example utilizing this framework is provided at the end of this section.)

00. <html>
01. <head>
02. <script>
03. function modifyText( ) {
04. var gauge = document.getElementById(‘td2’);
05. var sizes = new Array(38,48,59,67,78);
06. switch (gauge.clientHeight) {
07. case sizes[0]: //smallest
08. // desired modifications
09. break;
10. case sizes[1]: //smaller
11. // desired modifications
12. break;
13. case sizes[2]: //medium
14. // desired modifications
15. break;
16. case sizes[3]: // larger
17. // desired modifications
18. break;
19. case sizes[4]: //largest
20. // desired modifications
21. break;
22. // default:
23. return false;
24. }
25. return true;
26. }
27. </script>
28. </head>
29. <body>
30. </body>
31. </html>

B. Creating a Gauge

In the following sub-section, a gauge will be created to register the current selection in the browser's sizing interface—its Text Size menu.

As is subsequently described, an element will be included in the page as the basis for the gauge in steps 101 and 201. (Hereinafter referred to as the “gauge element”.)

To complete its creation as a gauge, the gauge element will be set to:
a. be sized by the browser to one of five predetermined sizes, each corresponding to a selection in the browser's Text Size menu in steps 102 and 202.
b. maintain its predetermined size unaffected by modifications made to the size-related settings for the other contents of the page in steps 103 and 203.
c. be hidden from the user's view in steps 104 and 204.

B-1. A table element containing a single tr (table row) element and a single td (table data) element with a blank space character (&nbsp;) within the td element is added to the page immediately after the opening tag of the body element as in lines 05 thru 07.

00. <html>
01. <head>
02. <script>As in A-1</script>
03. </head>
04. <body>
05. <table><tr>
06. <td>&nbsp;</td>
07. </tr></table>
08. </body>
09. </html>

The td element contains a blank space character (&nbsp;) because, should CSS be disabled in the user's browser and the table become visible, it will still be largely hidden from the user's view insofar as it would be “empty space” and, as such, visually unobtrusive and semantically meaningless.

In this embodiment, the td element in line 06 is the gauge element.

B-2. An id “t1” is added to the table element as in line 05 and id “td2” is added to the td element as in line 06.

00. <html>
01. <head>
02. <script> As in A-1</script>
03. </head>
04. <body>
05. <table id=“t1”><tr>
06. <td id=“td2”>&nbsp;</td>
07. </tr></table>
08. </body>
09. </html>

An id can be helpful in creating an object reference to the gauge element within the modification script as shown in A-1 line 04.

The choice of id name and whether or not to even apply one is, ultimately, left to the web developer. There are other ways of creating an object reference so there need not necessarily be an id. (See section IV for an example.) However, adding an id to the td element and its container, the table element, is also helpful in insulating these elements from any unwanted effects bleeding through to them from the other contents of the page. For instance, when used as a selector in a CSS style rule, an id has a high level of specificity that can help ensure that no other CSS style rule interferes with these elements behaving as expected.

At this point some comments about the terms “insulation”, “insulating”, and the considerations that give rise to them are presented:

As the practitioner skilled in the art is aware, simply by including one group of HTML elements within the same page as another group, relationships are automatically created between the two whereby the settings for one group can affect the settings of the other. This is problematical because allowing the settings for the other contents of the page to “bleed through” to the gauge element or two trigger elements can have undesirable effects. This is where the term “insulation” comes into play.

It was determined that, through a variety of techniques, countermeasures could be taken and unwanted effects flowing from the other contents of the page to these elements could be blocked. As will be shown, this is particularly helpful in setting the gauge element as a gauge that maintains its predetermined size unaffected by modifications to the size-related settings for the other contents of the page.

Furthermore, these unwanted settings can be blocked in varying degrees—and the elements therefore insulated—to suit the contents of the page and the nature of the modification script so that no more insulation than is necessary need be applied. This is one reason why the working examples contained in this description can look very different and yet contain applications of the same method.

In light of this, two basic approaches can be taken to applying the method. The first is to take a “minimal insulation” approach by analyzing the other contents of a particular page, the desired modifications, and then blocking only those settings that would prevent the gauge element and trigger elements from working as expected. (An example particularly illustrative of this is to be found in Section III; titled “Minimal”.)

The second approach is to aim for “maximum insulation” by attempting to block all possible settings that might prevent the gauge element and two trigger elements from working as expected no matter what the page's other contents may be. The advantage of this approach is that the resulting gauge and two triggers would be applicable to a wide a variety of pages.

In the interests of providing a complete and full description, the preferred embodiment presented in this section and the alternative embodiment presented in Section II both aim for “maximum insulation” and the gauge and two triggers created will therefore be applicable to pages containing a wide range of content.

These comments regarding insulation will take on added meaning as this description proceeds.

B-3. The following CSS style rules are applied to the table element (id=“t1”) and its child td element (id=“td2”) as shown in lines 04 thru 12.

00. <html>
01. <head>
02. <script> As in A-1</script>
03. <style>
04. #td2 {
05. font: x-large/normal arial!important;
06. padding:0!important;
07. }
08. #t1 {
09. position:absolute!important;
10. left:-9999px!important;
11. }
12. </style>
13. </head>
14. <body>
15. <table><tr>
16. <td id=“td2”>&nbsp;</td>
17. </tr></table>
18. </body>
19. </html>

As shown, all the CSS style rules have the “!important” declaration included. This is for stronger insulation. In accordance with the CSS recommendation, “!important” declarations give additional weight to the style rule so it will override any conflicting style rules that might interfere with the gauge element sizing as expected.

For example, a typical web page contains many style rules and there might be a rule that sets the font-size for all the td elements in the page as follows:
td {font-size: 1 em;}

In this case, the weightier (and preferred) CSS style rule shown in line 05 would override it and the td element (id=“td2”) would still have a font-size of x-large.

Understanding the reason for each of these CSS style rules is helpful to an understanding of the invention and therefore each warrants a thorough explanation. For simplicity, each style rule will be examined without the “!important” declaration.

First, there are the rules applied to the td element (id=“td2”):

font: x-large/normal arial

This rule is written using one of the CSS “shorthand” rules, and it sets three different properties of the element in one line.

In its expanded form, it would be written this way:

font-size: x-large

font-family: arial

line-height: normal

Each of these CSS style rules will now be explained in turn:

font-size: x-large

This rule governs how the single text character “&nbsp;” within the td element (and, therefore, the td element itself) will be sized by the browser during the loading phase and resized during the loaded phase.

Using a Font Size Keyword such as x-large is helpful for several reasons.

Unlike text characters set in pixels, text characters set using Font Size Keywords are sized and resized by the browser in response to the current selection in the Text Size menu. Since the size of the element containing this text is being used to determine the current selection in the browser's Text Size menu, the text should, first and foremost, be capable of changing size in response to changes in the Text Size menu.

Further, Font Size Keyword units are absolute units, meaning they are pixel-based. For any given font-family—Arial, Verdana, et al—and any given Font Size Keyword—xx-small, x-small, small, medium, large, x-large, and xx-large—the text will scale to a predictable pixel size in correspondence to each selection in the browser's Text Size menu—largest, larger, medium, smaller, and smallest.

With this information in hand, the sizes that correspond to each selection in the Text Size menu are next obtained: the web developer sets the text within the element to the desired size—xx-small, x-small, small, medium, large, x-large, or xx-large—and then measures the size of the element as it is scaled, in turn, by the five selections in the Text Size menu—largest, larger, medium, smaller, and smallest.

The use of such measurements can be seen in the modification script created in step A-1 line 05:
sizes=new Array(38,48,59,67,78);

Further, Font Size Keywords do not inherit their base size from their parent element as do other CSS units of measurement such as em or percent. This provides insulation in that modifications made to the font-size settings for the other contents of the page will have no effect on the base size of the element. This is especially helpful in ensuring that the gauge element maintains its predetermined size unaffected by modifications to the size-related settings for the other contents of the page.

Lastly, unlike text contained within a HTML Font element, for example, which also does not inherit its base size from a parent element, Font-Size Keywords are not deprecated under the current HTML recommendation. Using Font Size Keywords to style the text within a td element is valid HTML and XHTML. This is a matter of importance to those web developers who wish to author pages that take advantage of the efficiencies to be had in adhering to web standards as put forth by the W3C.

(One other possibility which would be “legal” under the rules of HTML and XHTML is to use a heading element such as h1, h2, h3, h4, h5, or h6. In accordance with the browser's default style rules, heading elements also do not inherit their base size from a parent element. There are two problems with this choice. The first is that many web developers explicitly set the font-size for heading elements using CSS style rules. This makes insulation difficult because these style rules would have to be counteracted by other style rules set more specifically for the gauge element. The second is that a heading element without any text content is semantically odd.)

font-family: arial

Although text set with any given Font-Family will scale predictably once having been set using a Font Size Keyword, Arial is preferred because it is native to all Internet Explorer installations. Arial is the default sans-serif Font-Family for all installations. Times New Roman, as the default serif Font-Family, would be as good a choice.

line-height: normal

Line height affects the amount of blank space over and below the text and will therefore affect the overall size of the gauge element. Line height can be inherited from a parent element as well.

Therefore, setting the line-height explicitly provides insulation in that modifications made to the line-height settings for the other contents of the page will have no effect on the line-height setting for this element.

padding: 0

Padding can also affect the overall size of the gauge element. Even though padding will not inherit from a parent element, if it is not set explicitly, it might be set by another rule in accordance with the CSS cascading order. For instance, if a value for padding was not set for the td element (id=“td2”), the cascade order would allow it to be set by another, broader rule that sets it for all td elements as in the following example:
td {padding:5px;}

Therefore, in this embodiment, padding is set explicitly as a precautionary measure. The settings for an element's borders can affect the overall size of the element but yet they are not being explicitly set for the gauge element in this embodiment. This is because insulation is provided by the mode of measurement being used by the modification script presented in A-1. The modification script uses the clientHeight property rather than the more common offsetHeight property to measure the gauge element. Since clientHeight does not take the width of an element's borders into account, the effects of any border settings for the gauge element are nullified and its measured size would remain unaffected by any border set for it.

Next discussed are the style rules set for the table element (id=“t1”)

position: absolute

left: −9999px

As styled by the browser's default style rules, the table element and its child elements will display as white-space margin at the top of the page. By using position:absolute, the table element and its child elements are removed from the normal flow of the document and the white-space margin is removed. However, the positioned table still hovers over the page at the default left:1px and top:1px position and could become visible if, for example, a background-color or border were applied to it. To insulate the element further and prevent this, it was discovered that the CSS style rule left:−9999px would position the table element so it is completely off screen. Once positioned this way, any CSS style rule that might affect it's becoming visible is nullified.

Of course, there is always the possibility that CSS might be disabled in the browser. (Statistically unlikely, but possible.) In such a case the table element will be displayed. That is the reason why the space character “&nbsp;” is used for the text content and the reason why the table contains a single row. If, instead of “&nbsp;” there were a text character like the letter “a” it would become visible in such a situation. Likewise, if the table contained more than a single row, it would become visually more obtrusive. In this way, the element is hidden from the user's view to the extent possible should CSS be disabled.

C. Creating a Loading Phase Trigger

In the following sub-section, a trigger is created to activate the modification script during the loading phase.

An element will be included in the page as the basis for a loading phase trigger in step 105. (Hereinafter referred to as the “loading phase trigger element”.)

To complete its creation as a loading phase trigger, the loading phase trigger element will be set to:
1. activate the modification script in step 106.
2. be hidden from the user's view in step 107.

C-1. An HTML script element is included in the page immediately after the table element as is shown in line 09. In addition, script code is included within this script element which will activate the modification script as is also shown in line 09.

00. <html>
01. <head>
02. <script>As in A-1</script>
03. <style>As in B-3</style>
04. </head>
05. <body>
06. <table><tr>
07. <td id=“td2”>&nbsp;</td>
08. </tr></table>
09. <script>modifyText( );</script>
10. </body>
11. </html>

HTML script elements are not displayed by the browser and are, therefore, inherently hidden from the user's view so no further work needs to be done to make it so.

However, while a script element is preferred as the loading phase trigger element, there are other possibilities.

For example, an element with an event attached to it could also serve to activate the modification script.

The following is an HTML image element with an onload event attached:
<img src=“spacer.gif” onload=“modifyText( )”/>

Although additional style rules would need to be set to hide it from the user's view and the image file (spacer.gif) would need to be placed on the web server, an element so created could also be used as a loading phase trigger.

At this point, the loading phase half of the invention is deployed. The page has now been prepared, as the page loads in the browser, to modify the page's size-related settings and, therefore, it's sizing behavior, in reference to the current selection in the browser's Text Size menu.

The browser is a text file interpreter that parses the page from the top down. In light of this, operationally, what happens when the browser loads the page is as follows:
1. Upon encountering the first group of elements after the body element (the table element and its child elements) the browser sizes the td element (id=“td2”) to one of five predetermined sizes corresponding to the current selection in the browser's Text Size menu. The browser does not display these elements because they have been set to be hidden from the user's view.
2. Next, upon encountering the script element, the browser's display process is interrupted by the activation of the modification script and:
   a. The modification script references the current selection in the Text Size menu by measuring the size of the td element and comparing it, in turn, to each of five predetermined sizes until it finds a match.
   b. The modification script modifies the size-related settings of the other contents of the page.
   c. The td element maintains its predetermined size unaffected by modifications made to the size-related settings for the other contents of the page.
3. Once the modification script is finished, the browser continues on to display the other contents of the page in accordance with the newly modified size-related settings.

D. Creating a Loaded Phase Trigger

As described in the following sub-section, an element will be included in the page as the basis for a loaded phase trigger in step 205. (Hereinafter referred to as the ‘loaded phase trigger element’.) To complete its creation as a loaded phase trigger, the loaded phase trigger element will be set to:
1. activate the modification script in reaction to a change of selection in the browser's Text Size menu in step 206.
2. be hidden from the user's view in step 207.

D-1. An onmove event is attached to the td element (id=“td2”) as shown in line 07.

00. <html>
01. <head>
02. <script>As shown in A-2</script>
03. <style>As shown in B-3</style>
04. </head>
05. <body>
06. <table id=“t1”><tr>
07. <td id=“td2” onmove=“modifyText( )”>&nbsp;</td>
08. </tr></table>
09. <script>modifyText( )</script>
10. </body>
11. </html>

This sets the td element (id=“td2”) to activate the modification script when it is moved. However, in order to get it to move in reaction to a change of selection in the browser's Text Size menu, another element set to be resizable must be inserted adjacent to it. Then, when a change in selection occurs, the adjacent element resizes, “bumps” into the adjacent td element (id=“td2”), and causes it to move.

The onmove event then fires and activates the modification script.

D-2. And so, an additional td element with a blank space character (id=“td1”) is added to the table element created in step B-1 as shown in line 07.

00. <html>
01. <head>
02. <script>As shown in step A-1</script>
03. <style>As shown in B-3</style>
04. </head>
05. <body>
06. <table id=“t1”><tr>
07. <td id=“td1”>&nbsp;</td>
08. <td id=“td2”>&nbsp;</td>
09. </tr></table>
10. <script>modifyText( )</script>
11. </body>
12. </html>

D-3. The same CSS style rules that were applied to the td element (id=“td2”) in B-3, are applied to the td element (id=“td1”) by adding the element's id selector to the CSS style rules as in line 04.

00. <html>
01. <head>
02. <script>As shown in step A-2</script>
03. <style>
04. #td1,#td2 {
05. font: x-large/normal arial!important;
06. padding:0!important;
07. }
08. #t1 {
09. position:absolute!important;
10. left:-9999px!important;
11. }
12. </style>
13. </head>
14. <body>
15. <table id=“t1”><tr>
16. <td id=“td1”>&nbsp;</td>
17. <td id=“td2”>&nbsp;</td>
18. </tr></table>
19. </body>
20. </html>

By virtue of its being contained within the table element, which was set to be hidden from the user's view in B-3, all of the table element's child td elements were also set to be hidden.

The td element (id=“td2”) is now configured as a loaded phase trigger set to react to a change of selection in the browser's Text Size menu by activating the modification script.

In this embodiment, the gauge element and the loaded phase trigger element are the same HTML td element.

Operationally, what happens when the user makes a change of selection in the Text Size menu is as follows:
1. The browser sizes the td element (id=“td2”) to one of five predetermined sizes corresponding to the current selection in the browser's Text Size menu. It also sizes the td element (id=“td1”) causing it to grow larger or smaller in width. The browser does not display these elements because they have been set to be hidden.
2. The td element (id=“td2”) moves either left or right to accommodate the adjacent td element's (id=“td1”) newly expanded or contracted size.
3. The onmove event attached to the td element (id=“td2”) interrupts the usual workings of the browser's response to a change of selection in the Text Size menu by activating the modification script:
   a. The modification script references the current selection in the Text Size menu by measuring the size of the td element and comparing it, in turn, to each of five predetermined sizes until it finds a match.
   b. The modification script modifies the size-related settings for the other contents of the page.
   c. The td element (id=“td2”) maintains its predetermined size unaffected by modifications to the size-related settings for the other contents of the page.
4. Once the modification script is finished, the browser continues on to re-display the contents of the page in accordance with the newly modified size-related settings.

While it might be expected that the page would first re-display the page according to the usual workings of the browser's Text Size menu and then the page would be re-displayed yet again in response to the execution of the modification script, causing a sudden and visible size adjustment, it was discovered that in practice this does not happen. To the user, the general effect retains the same “look and feel” as what takes place when the page is set using only “resizable” CSS units of measurement such as em or percent.

Note: The Font Size Keyword x-large is used in this embodiment because the blank space character (&nbsp;) for font-family Arial, if it is set to anything smaller than x-large, fails to expand or contract its width in response to each of the five selections in the browser's Text Size menu.

Utilizing the onmove event can also be achieved using div and span elements as follows:

Substitute this for the table element:

<div id=“d1”><span id=“s1”></span>
<span id=“s2” onmove=“modifyText( );”></span>
</div>

Substitute these style rules for those applied to the table and td elements:

#d1{position:absolute!important;left:-9999px!important;}
#s1,#s2{display:block!important;width:20px!important;font:
x-small/normal arial!important;
padding:0!important;}

Change the appropriate lines in the modification script to:

var sizes = new Array(14,15,16,18,22)
var gauge = document.getElementById(‘s2’);

Using div and span elements is valid HTML and has the added advantage of working without blank text characters within any of the elements. (For reasons unknown, the browser treats these elements as if they contained textual content.)

F. Disabling the Gauge and Two Triggers in Other Browsers

Although this step would not be necessary, for example, in an environment such as a company Intranet where everyone in the organization is required to use the current version of IE, it is generally a good idea to disable the gauge and two triggers when the page can possibly be viewed in other browsers. In this embodiment, the disabling is done by putting the gauge element, the loading phase trigger element, and the loaded phase trigger element within conditional comments as shown in lines 06 thru 12. (The style rules configuring these elements will have no effect if the browser ignores the elements themselves and so the style rules can be left uncommented.)

00. <html>
01. <head>
02. <script>As in A-1</script>
03. <style>As in D-3</style>
04. </head>
05. <body>
06. <!--[if gte IE 5.5]>
07. <table id=“t1”><tr>
08. <td id=“td1”>&nbsp;</td>
09. <td id=“td2” onmove=“modifyText( )”>&nbsp;</td>
10. </tr></table>
11. <script>modifyText( )</script>
12. <![endif]-->
13. </body>
14. </html>

Conditional comments were introduced with Microsoft Internet Explorer version 5.0 in 1999. By using the syntax: “<!—[if gte IE 5.5”>, the commented HTML code will be interpreted or “seen” only by versions IE 5.5 and higher.

This is helpful in this embodiment because the onmove event was introduced with IE version 5.5. and doesn't exist in versions of IE with a lesser version number.

G. Complete Working Example

<html><head>
<title>Preferred Embodiment Example</title>
<style>body {font-size: 16px;}
#t1{position:absolute!important;left:-9999px!important;}
#td1,#td2{font: x-large/normal arial!important;padding:0!important;}
</style>
<noscript><style>body{font-size: 100%;}</style></noscript>
<script>
function modifyText( ) {
var sizes = new Array(24,32,36,42,49)
var gauge = document.getElementById(‘td2’);
switch (gauge.clientHeight) {
case sizes[0]:document.body.style.zoom = ‘90%’;break;
case sizes[1]:document.body.style.zoom = ‘95%’;break;
case sizes[2]:document.body.style.zoom = ‘100%’;break;
case sizes[3]:document.body.style.zoom = ‘110%’;break;
case sizes[4]:document.body.style.zoom = ‘120%’;break;
default:return false;}return true;}
</script></head>
<body>
<!--[if gte IE 5.5]>
<table id=“t1”><tr><td id=“td1”>&nbsp;</td><td id=“td2”
onmove=“modifyText( );”>&nbsp;</td></tr></table>
<script>modifyText( );</script>
<![endif]-->
This example is meant to be viewed in Internet Explorer.
<p>
Every web developer knows that “Internet Explorer can't resize
pixels”.<br />
But this method changes that.<br />
The font-size for the body of this page has been set in pixels.<br />
But yet when you go to the View menu and choose another selection
in the Text Size menu, the text resizes!<br />
</p>
</body></html>

III. Alternative Embodiment

A. Creating a Modification Script

A-1. This is the same as presented in Section II A-1 except for these changes:

var sizes = new Array(10,12,13,16,18)
var gauge = document.getElementById(‘f17495003’);

B. Creating a Gauge Element

B-1. A div element is placed as the last element of the body section of the page as in line 05. Additionally, a blank space character (&nbsp;) is placed within the div element.

00. <html>
01. <head>
02. <script>As in A-1</script>
03. </head>
04. <body>
05. <div>&nbsp;</div>
06. </body>
07. </html>

B-2. A unique id “f17495003” is added to the div element as in line 05.

00. <html>
01. <head>
02. <script>As in A-1</script>
03. </head>
04. <body>
05. <div id=“f17495003”>&nbsp;</div>
06. </body>
07. </html>

Here, the id name is the letter “f” followed by a string of numbers randomly chosen.

B-3. CSS style rules are applied as in lines 03 thru 10.

00. <html>
01. <head>
02. <script>As in A-1</script>
03. <style>
04. #f17495003 {
05. font: xx-small/normal arial!important;
06. padding:0!important;
07. position:absolute!important;
08. left:-9999px!important;
09. }
10. </style>
11. </head>
12. <body>
13. <div id=“f17495003”>&nbsp;</div>
14. </body>
15. </html>

The div element in line 13 is now set as a gauge.

C. Creating the Loading Phase Trigger

C-1. An onload event is attached to the window object using the attachEvent method. This will activate the modification script as in line 03.

00. <html>
01. <head>
02. <script>
03. window.attachEvent(‘onload’,modifyText)
04. - Script as in A-1 -
05. </script>
06. <style>As in B-3</style>
07. </head>
08. <body>
09. <div id=“f17495003”>&nbsp;</div>
10. </body>
11. </html>

If no onload event yet exists for the body element in the page to which this method is being applied, then using the attachEvent method of the window object is the equivalent of “hard coding” the following line:
<body onload=“modifyText( );”>

However, it is not uncommon for the body element of a web page to contain an onload event unrelated to this method. Using window.attachEvent automates the process of adding the event to what already exists. If, for example, there were already an onload event calling a script function named “greeting( )”, using attachEvent would be the equivalent of writing:
<body onload=“greeting( );modifyText( );”>

Scripting the insertion of the onload event using attachEvent insures that the script function modifyText will be the last block of script fired by the window's onload event.

The body element is now a loading phase trigger that activates the script created in step A-1.

At this point, the loading phase half of the invention is deployed. The page has now been prepared, as the page loads in the browser, to modify the page's size-related settings and, therefore, it's sizing behavior, in response to the current selection in the browser's Text Size menu.

Operationally, what happens when the browser loads the page is as follows:
1. The browser begins receiving the contents of the page.
2. At the very end of the loading phase, when all the contents of the page have been received by the browser, the onload event fires and the modification script is activated.
   a. The modification script references the current selection in the Text Size menu by measuring the size of the div element and comparing it, in turn, to each of five predetermined sizes until it finds a match.
   b. The modification script modifies the size-related settings of the other contents of the page.
   c. The div element maintains its predetermined size unaffected of the modifications made by the script.
3. Once the modification script is finished, the browser displays the other contents of the page in accordance with the newly modified size-related settings.

This embodiment of the loading phase half is quite viable for many purposes. Unlike the preferred embodiment, by using the body element as the loading phase trigger, the modification script is able to traverse the entire Document Object Model or ‘document tree’ to make its modifications during the loading phase. This can't be done with the preferred embodiment because the parsing of the document is interrupted soon after the opening tag of the body element and the “document tree” does not, as yet, exist to be scripted.

Be aware that this may result in a sudden and visible size adjustment caused by the browser first displaying a part of the page's contents in accordance with the unscripted settings written into the page and then suddenly re-displaying the page in accordance with the new settings when the modification script runs. However, for many web pages, this does not seem to be an issue. For example, it was discovered that for fairly short pages containing only text, the modification—for reasons unknown—appears to take place before the browser makes the contents of the page visible and the display is smooth.

In contrast, for more complicated pages, especially those using table-based layouts containing images, the browser does begin to display the contents of the page before the onload event fires and there will be a visible readjustment as the browser resizes the contents of the page in response to the modifications made by the modification script. This behavior will depend upon the contents of the page and is difficult to determine in advance without experimentation.

Since the main advantage to using the body element as the loading phase trigger element is that it allows the modification script to use the Document Object Model (DOM) to move through all the objects within the body, if there is no compelling reason to do that, it is recommended that the web developer use a loading phase trigger constructed in keeping with the preferred embodiment as presented in Section II. (A complete working example using this approach is presented in Section IV; titled “Hybrid”.)

Insofar as one object of the present invention is for its deployment to be transparent to the user, if using the body element as the loading phase trigger is greatly desired, one way to ensure that the modification script is activated before the contents of the page are displayed is to suppress the display of the contents of the page and then, in the modification script, release the suppression using the following lines of script or their equivalents:

document.body.style.visibility=“hidden”; \\ This will suppress display
document.body.style.visibility=“visible”; \\ This displays the page

The use of this optional enhancement to the loading phase trigger in this embodiment is demonstrated in the working example at the end of this section.

At this point, the first half of the invention is deployed.

D. Creating a Loaded Phase Trigger

A. An onresize event activating the modification script is attached to the div element as in line 09.

00. <html>
01. <head>
02. <script>
03. window.attachEvent(‘onload’,modifyText)
04. - Script as in A-1 -
05. </script>
06. <style>As in Step B-3</style>
07. </head>
08. <body>
09. <div id=“f17495003” onresize=“modifyText( )”>&nbsp;</div>
10. </body>
11. </html>

The div element is now configured as the loaded phase trigger and the loaded phase half of the method is complete.

Operationally, what happens when the user makes a change of selection in the Text Size menu is as follows:
1. The browser resizes the div element to one of five predetermined sizes corresponding to the current selection in the browser's Text Size menu.
2. Upon the resizing of the div element, the browser's usual response to a change in the Text Size menu is interrupted by the onresize event's activation of the modification script:
   a. The modification script references the current selection in the Text Size menu by measuring the size of the div element and comparing it, in turn, to each of five predetermined sizes until it finds a match.
   b. The modification script modifies the size-related settings of the other contents of the page.
   c. The div element maintains its predetermined size unaffected of the changes made by the modification script to the other contents of the page.
3. Once the modification script is finished, the browser continues on to re-display the contents of the page in accordance with the newly modified size-related settings.

This loaded phase embodiment has much to recommend it and is, in many ways, of equal value to the previous embodiment which uses the onmove event. The onresize event is available in IE versions 5.0 and higher as opposed to the onmove event being available only in IE versions 5.5 and higher.

However, it is a known fact that the onresize event does not work reliably with pages that contain embedded controls such as Flash animations and this is the main reason for it being presented here within an alternative embodiment. However, for a page where it is known that there is no embedded control to interfere with it, the onresize event works reliably and applies to more versions of IE than does the onmove event.

F. Disabling the Gauge and Two Triggers in Other Browsers

The invention is partially hidden and therefore prevented from functioning when viewed in other browsers by putting the gauge element, the loading phase trigger element, the loaded phase trigger element and the modification script within conditional comments as in lines 02 thru 07 and lines 11 thru 13. Note that the conditional comments differ from the preferred embodiment to reflect the addition of IE version 5 to the scope.

00. <html>
01. <head>
02. <!--[if IE 5]>
03. <script>
04. window.attachEvent(‘onload’,modifyText)
05. - Script as in Step A-1 -
06. </script>
07. <![endif]-->
08. <style>As in Step B-3</style>
09. </head>
10. <body>
11. <!--[if IE 5]>
12. <div id=“f17495003” onresize=“modifyText( )”>&nbsp;</div>
13. <![endif]-->
14. </body>
15. </html>

VII. Working Example

<html><head>
<title>Alternative Embodiment</title>
<style>body {font-size: 14px;}
#f17495003{font:xx-small/normal arial!important;padding:0!important;
position:absolute!important;left:-9999px!important;}</style>
<noscript><style>body{font-size:76%;}</style></noscript>
<!--[if IE]>
<script>
window.attachEvent(‘onload’,modifyText);
function modifyText( ) {
document.body.style.visibility = ‘visible’;
sizes = new Array(10,12,13,16,18);
var gauge = document.getElementById(‘f17495003’);
switch (gauge.clientHeight) {
case sizes[0]:document.body.style.fontSize = ‘12px’;break;
case sizes[1]:document.body.style.fontSize = ‘13px’;break;
case sizes[2]:document.body.style.fontSize = ‘14px’;break;
case sizes[3]:document.body.style.fontSize = ‘15px’;break;
case sizes[4]:document.body.style.fontSize = ‘16px’;break;
default:return false;}return true;}
</script>
<![endif]-->
</head>
<body>
<!--[if IE]><script>
document.body.style.visibility = ‘hidden’;
</script><![endif]-->
This example is meant to be viewed in Internet Explorer.
<p>
Many web developers object to the 16px default text size imposed by
the browser as being too large.<br />
Yet if you override it by setting the text for body at a lower pixel size,
then Internet Explorer loses the ability to resize the text.</br />
But this method changes that.<br />
</p>
<!--[if IE]>
<div id=“f17495003” onresize=“modifyText( );”>&nbsp;</div>
<![endif]-->
</body>
</html>

Some further comments regarding insulation are now presented:

Sometimes it is easiest to see how and why something needs to be done by witnessing the effects when it is not done. The effects of insufficient insulation, that is, of allowing a size-related setting for another element to bleed through and prevent the gauge from maintaining its predetermined size unaffected by modifications to the size-related settings for other contents of the page can be seen in the following embodiment of the loading phase half of the method.

A very common way for web developers to change the text size of an entire page is to set a base font-size for the body element. Because the base font-size is, by default, inherited by child elements from their parent element, setting the font-size for body can be used to enlarge or reduce font-sizes for the entire page. This is desirable in that many web developers feel that the browser default font-size of 100% equaling 16 pixels is too large and they will often downsize the text using one technique or another.

Now, let's assume that the font-size for the body element is set to 90% but that when ‘smallest’ is the current selection in the Text Size menu; the setting of 90% leaves the text too small when the page first loads. Let's further assume that, in an attempt to remedy this, the web developer includes a gauge element that (wrongly) has its font-size unset so that it inherits its base font size from its parent element, the body element.

In keeping with the method, the web developer measures the size of this gauge element as it is sized, in turn, by the browser at the five selections available in its Text Size menu: smallest, smaller, medium, larger, and largest, and comes up with these sizes: 14,15,16,19,22. These sizes are then incorporated into a modification script which is activated by a loading phase trigger.

Lastly, let's also assume that when smallest is the current selection in the Text Size menu, the modification script boosts the size of the text by changing the font-size setting for the body element to font-size=100%.

Here is how one embodiment for this loading phase half of the method as just described would look like. Remember that, for illustrative purposes, it contains a deliberate deviation from the method:

<html>
<head>
<style>body{font-size:90%;font-family:arial;}
#g{font-family:arial;position:absolute!important;left:−9999px!important;}
</style>
<script>
function modifyText( ) {
var sizes = new Array(14,15,16,19,22);
var gauge = document.getElementById(‘g’);
var d = document.body.style
switch (gauge.clientHeight) {
case sizes[0]: d.fontSize = ‘100%’;break;
case sizes[1]: d.fontSize = ‘95%’;break;
case sizes[2]: d.fontSize = ‘90%’;break;
case sizes[3]: d.fontSize = ‘85%’;break;
case sizes[4]: d.fontSize = ‘80%’;break;
default:return false;}return true;}
</script></head>
<body>
<div id=“g”>&nbsp;</div>
<script>modifyText( );</script>
This example is meant to be viewed in Internet Explorer.
</body>
</html>

Will this enlarge the text, as the page loads, from what it would normally be if left unmodified?

Yes, but the functionality of the gauge ends at that point. With the body element now having a setting of 100%, the gauge element now measures 15 instead of 14 and its predeterminable sizes corresponding to the five selections in the Text Size menu have changed to 15,16,18,22, and 24. At this point, the modification script can no longer reference the gauge element reliably and the loaded phase half of the method, if it is to share the same gauge and modification script as the loading phase half, cannot be deployed successfully.

However, the problem is easily fixed by further insulating the gauge element with the following style rule:
font-size:x-small!important;
and amending the predetermined sizes within the modification script to reflect that change:
var sizes=new Array(14,15,16,18,22)

With the addition of this style rule to block the modifications to the font-size setting for body from affecting the gauge element, the gauge element is now a part of a properly configured gauge set to maintain its predetermined size unaffected by modifications made to the size-related settings for the other contents of the page—in this case the body element.

The size of the body element can now be modified to whatever the web developer deems appropriate, including setting it in pixel units. And a loaded phase half of the method sharing the same gauge and modification script can be deployed, as well.

It should also be noted at this point that it is possible for the gauge to maintain its predetermined size affected by the size-related settings for the other contents of the page.

If, for example, the remedial action built into the modification script in the previous example was setting the font-size for the body element to 95% rather than 100% at a selection of ‘smallest’, then the gauge element would still measure 14 pixels both before and after the modification script was activated. This would mask the underlying problem engendered by insufficient insulation because, even though the size has been maintained for a setting of ‘smallest’, at a font-size for body of 95%, the potential sizes corresponding to the five selections in the Text Size menu have still altered to 14, 16, 17, 21, and 23. Therefore, to make sure that the predetermined size is being maintained unaffected by modifications to the size-related settings for the other contents of the page, the web developer is advised to debug using large increments within the modification script. This will lessen the possibility of the browser scaling the gauge element to the same size before and after the modification script has been activated and help reveal any ‘break’ in the insulation.

IV. Conclusion, Ramifications, and Scope

While the preceding description contains many specifics, these should not be construed as limitations on the scope of the invention, but rather as exemplifications of one preferred embodiment and an alternative embodiment of roughly equal utility.

Many other variations are possible.

The following is a “hybrid” example combining the loading phase method presented in Section III with the loaded phase method presented in Section IV:

<html>
<head>
<title>Hybrid Embodiment</title>
<style>body {font-size: 14px;}
#f17495003{font:xx-small/normal arial!important;padding:0!important;
position:absolute!important;left:−9999px!important;}
</style>
<noscript>
<style>body{font-size:76%;}</style>
</noscript>
<script>
function modifyText( ) {
sizes = new Array(10,12,13,16,18)
var gauge = document.getElementById(‘f17495003’);
switch (gauge.clientHeight) {
case sizes[0]: document.body.style.fontSize = ‘12px’;break;
case sizes[1]: document.body.style.fontSize = ‘13px’;break;
case sizes[2]: document.body.style.fontSize = ‘14px’;break;
case sizes[3]: document.body.style.fontSize = ‘15px’;break;
case sizes[4]: document.body.style.fontSize = ‘16px’;break;default:
return false;}return true;}
</script>
</head>
<body>
<div id=“f17495003” onresize=“modifyText( );”>&nbsp;</div>
<script>modifyText( );</script>
This example is meant to be viewed in Internet Explorer.
</body>
</html>

The following is an example of a text-only page that aims at using the least number of elements and style rules to create the special elements as is possible:

<html>
<head>
<title>Minimal</title>
<style>body{font-size:16px;}#g{position:absolute;}</style>
<script>
function modifyText( ) {
var s = new Array(15,19,20,24,26)
var g = document.getElementById(‘g’);
var d = document.body.style
switch (g.offsetHeight) {
case s[0]: d.zoom = ‘90%’;break;
case s[1]: d.zoom = ‘95%’;break;
case s[2]: d.zoom = ‘100%’;break;
case s[3]: d.zoom = ‘110%’;break;
case s[4]: d.zoom = ‘120%’;break;
return false;}return true;}
</script>
</head>
<body>
<h3 id=“g” onresize=“modifyText( )”></h3>
<script>modifyText( );</script>
<p>
The font-size for the body of this page has been set in pixels.<br />
</p>
</body>
</html>

The h3 element is the gauge element and the loaded phase trigger element. Sufficient insulation is achieved using only the browser's default style rules plus a single style rule added to make the special elements invisible: #g{position:absolute}. Note that the browser does not require that a blank text character (&nbsp;) be placed within the h3 element in order for it to size and resize.

This next example also looks quite unlike the embodiments presented in Sections II and III:

<html>
<head>
<title>Deployment Possibilities</title>
<style>body {font-size: 16px;}</style>
</head>
<body>
<script>
function modifyText( ) {
var sizes = new Array(15,19,20,24,26)
var g = document.body.all.item(1);
var d = document.body.style
switch (g.clientHeight) {
case sizes[0]:d.zoom = ‘90%’;break;
case sizes[1]:d.zoom = ‘95%’;break;
case sizes[2]:d.zoom = ‘100%’;break;
case sizes[3]:d.zoom = ‘110%’;break;
case sizes[4]:d.zoom = ‘120%’;break;
default:return false;}
return true;}
if ((navigator.platform==‘Win32’)&&
(navigator.appName==‘Microsoft Internet Explorer’))
var y = document.body
var x = document.createElement(‘h3’)
x.innerText = ‘ ’;
x.style.position = ‘absolute’;x.style.left = ‘-9999px’;
y.appendChild(x);
x.attachEvent(‘onresize’,modifyText);
modifyText( );
</script>
<p>This example is meant to be viewed in Microsoft
Internet Explorer.</p>
</body>
</html>

Among the differences are: a unique id is not used for any element; the script element that contains the modification script is not placed in the head section of the page but rather in the body; the special elements are hidden from other browsers using browser detection rather than conditional comments; and a heading (h3) element is used for the gauge element and loaded phase trigger element rather than a div or a td element.

Also, rather than “hard coding” the special elements into the page, in this example some of the special elements are created using script. This technique allows the method to become highly automated in that it can be deployed “on the fly” as the page loads in the browser.

It also allows for the method to be applied to multiple pages in a web site using an external script file. For example, if the contents of lines 09 through 29 were to be placed in a single file named “method.js” on the web server, it could be included in every page on the web site with just a single element on each page, like this:
<script src=“method.js”></script>

Further, bunching everything together within a single script element makes it easier to include it within multiple pages using server-side includes; an alternative to using the external script file just described.

This example works fine because all of these things are details of implementation.

What's helpful is that all of the special elements—gauge, loading phase trigger, and loaded phase trigger—are clearly present even if they appear in a form differing from what was presented in Sections II and III.

Accordingly, the scope of the invention should be determined not by the embodiments illustrated, but by the appended claims and their legal equivalents.

A few words about other uses:

This method can be highly useful as a means of gathering statistics about the user's settings in the browser's Text Size menu. The script triggered by either (or both) the loading phase trigger element and the loaded phase trigger element can contain script that makes a request to the web server (done in the background and hidden from the user) indicating what Text Size menu setting is currently in force. These requests can be logged on the server-side to give the web developer a sense of what settings are being used most frequently by visitors to their web site. The script making these requests could be implemented in addition to whatever modification of the sizing or resizing behavior is already in place or alone by itself.

It should also be noted that the script triggered by the loading phase trigger element and the loaded phase trigger need not be exactly the same script. There are, remember, two ‘halves’ to the method, analogous to the default behavior of the browser as it applies the settings in the Text Size menu during the loading and loaded phases. Either half can be deployed separately, if desired.

Lastly, it should be noted that the special elements created in the course of applying the method presented here are, in essence, ‘middleware’ connecting the browser's Text Size menu to the browser's script interpreter. As such, there is no inherent limitation on the kind of script that might be activated—be it related to the sizing and resizing of the page's contents as focused on here, or not.

1) A method for modifying a sizing behavior of a web page of a browser having contents as said web page loads in said browser performing the steps of:
a) including in said web page a gauge for registering the current selection in said browser's sizing interface as said web page loads in said browser
(b) including in said web page a trigger for activating script in said web page whereby said sizing behavior of said web page may be modified in reference to the current selection in said browser's sizing interface

2) The method of claim 1, wherein said gauge is further comprised of an element set to be sized by said browser to one of a plurality of predetermined sizes each corresponding to a selection in said browser's sizing interface

3) The method of claim 1, wherein said gauge is further comprised of an element set to maintain its predetermined size unaffected by modifications to said sizing behavior set for the other contents of the page

4) The method of claim 1, wherein said trigger is further comprised of an element set to activate said script in said web page

5) The method of claim 1, wherein said gauge and said trigger is further comprised of an element set to be hidden from the browser user's view

6) An apparatus for modifying a sizing behavior of a web page of a browser having contents as said web page first loads in said browser comprising the apparatus performing the steps of:
a) including in said web page a gauge for registering the current selection in said browser's sizing interface as said web page loads in said browser
(b) including in said web page a trigger for activating script in said web page whereby said sizing behavior of said web page may be modified in reference to the current selection in said browser's sizing interface

7) The apparatus of claim 6, wherein said gauge is further comprised of an element set to be sized to one of a plurality of predetermined sizes each corresponding to a selection in said browser's sizing interface

8) The apparatus of claim 6, wherein said gauge is further comprised of an element set to maintain its predetermined size unaffected by modifications to said sizing behavior set for the other contents of the page

9) The apparatus of claim 6, wherein said trigger is further comprised of an element set to activate script in said web page

10) The apparatus of claim 6, wherein said gauge and said trigger is further comprised of an element set to be hidden from the browser user's view

11) A system for modifying a sizing behavior of a web page of a browser having contents as said web page first loads in said browser comprising the system performing the steps of:
a) including in said web page a gauge for registering the current selection in said browser's sizing interface as said web page loads in said browser
(b) including in said web page a trigger for activating script in said web page whereby said sizing behavior of said web page may be modified in reference to the current selection in said browser's sizing interface

12) The system of claim 11, wherein said gauge is further comprised of an element set to be sized to one of a plurality of predetermined sizes each corresponding to a selection in said browser's sizing interface

13) The system of claim 11, wherein said gauge is further comprised of an element set to maintain its predetermined size unaffected by modifications to said sizing behavior set for the other contents of the page

14) The system of claim 11, wherein said trigger is further comprised of an element set to activate script in said web page

15) The system of claim 11, wherein said gauge and said trigger is further comprised of an element set to be hidden from the browser user's view

16) A method for modifying a resizing behavior of a web page of a browser having contents when said web page is loaded in said browser comprising:
(a) including in said web page a gauge for registering the current selection in said browser's sizing interface
(c) including in said web page a trigger for activating script in said web page whereby said resizing behavior of said web page may be modified in reference to the current selection in said browser's sizing interface

17) The method of claim 16, wherein said gauge is further comprised of an element that's size is set to be one of a plurality of predetermined sizes each corresponding to a selection in said browser's sizing interface

18) The method of claim 16, wherein said gauge is further comprised of an element set to maintain its predetermined size unaffected by modifications to said sizing behavior set for the other contents of the page

19) The method of claim 16, wherein said gauge is further comprised of an element set to be hidden from the browser user's view

20) The method of claim 16, wherein said trigger is further comprised of an element set to activate script in reaction to a change of selection in said browser's resizing interface

21) The method of claim 16, wherein said trigger is further comprised of an element set to be hidden from the browser user's view

22) An apparatus for modifying a resizing behavior of a web page of a browser having contents when said web page is loaded in said browser comprising the apparatus performing the steps of:
(a) including in said web page a gauge for registering the current selection in said browser's sizing interface
(b) including in said web page a trigger for activating script in said web page whereby said resizing behavior of said web page may be modified in reference to the current selection in said browser's sizing interface

23) The apparatus of claim 22, wherein said gauge is further comprised of an element that's size is set to be one of a plurality of predetermined sizes each corresponding to a selection in said browser's sizing interface

24) The apparatus of claim 22, wherein said gauge is further comprised of an element set to maintain its predetermined size unaffected by modifications to said sizing behavior set for the other contents of the page

25) The apparatus of claim 22, wherein said gauge is further comprised of an element set to be hidden from the browser user's view

26) The apparatus of claim 22, wherein said trigger is further comprised of an element set to activate script in reaction to a change of selection in said browser's resizing interface

27) The apparatus of claim 22, wherein said trigger is further comprised of an element set to be hidden from the browser user's view

28) A system for modifying a resizing behavior of a web page of a browser having contents when said web page is loaded in said browser comprising the system performing the steps of:
(a) including in said web page a gauge for registering the current selection in said browser's sizing interface
(b) including in said web page a trigger for activating script in said web page whereby said resizing behavior of said web page may be modified in reference to the current selection in said browser's sizing interface

29) The system of claim 28, wherein said gauge is further comprised of an element that's size is set to be one of a plurality of predetermined sizes each corresponding to a selection in said browser's sizing interface

30) The system of claim 28, wherein said gauge is further comprised of an element set to maintain its predetermined size unaffected by modifications to said sizing behavior set for the other contents of the page

31) The system of claim 28, wherein said gauge is further comprised of an element set to be hidden from the browser user's view

32) The system of claim 28, wherein said trigger is further comprised of an element set to activate script in reaction to a change of selection in said browser's resizing interface

33) The system of claim 28, wherein said trigger is further comprised of an element set to be hidden from the browser user's view
